(19) United States
(12) Patent Application Publication
(10) Pub. No.: US 2008/0221710 A1
(43) Pub. Date: Sep. 11, 2008

(54) SYSTEM AND METHODS FOR REDUCING AN EFFECT OF A DISTURBANCE

(75) Inventor: Brent Jerome Brunell, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/925,145

(22) Filed: Oct. 26, 2007

Related U.S. Application Data
(63) Continuation-in-part of application No. 11/549,320, filed on Oct. 13, 2006.

(51) Int. Cl. G05B 13/02

(52) U.S. Cl. 700/45

(57) ABSTRACT

A method and system for reducing disturbance effects on a dynamic system. The method in one embodiment processes a compensated control signal using at least one of a feedforward gain, feedthru gain and a feedback gain, and transmitting the compensated control signal to the dynamic system. An embodiment of the dynamic disturbance rejection device comprises a feedthru section with at least one input command signal that processes a feedthru output using inverse system dynamics, a feedback section with state information that processes a feedback output using inverse system dynamics, a feedforward section with disturbance information that processes a feedforward output using inverse system dynamics, and a processing unit that processes the compensated control signal for the controlled system.

### RELATED APPLICATIONS

This application is a continuation-in-part of U.S. application Ser. No. 11/549,320, filed Oct. 13, 2006 and is herein incorporated in its entirety by reference.

### STATEMENT REGARDING FEDERALLY SPONSORED RESEARCH & DEVELOPMENT

The invention described herein was made with Government support under Contract No. N00019-96-C-0176 awarded by the Department of Defense. The Government has certain rights to the invention.

### FIELD OF THE INVENTION

The invention generally relates to control systems, and more particularly, to systems and methods for reducing the effects of disturbances for the system.

### BACKGROUND

A dynamic system, such as a gas turbine, wind turbine, an engine, a motor, or a vehicle, has at least one input and provides at least one output based on the input(s). However, the dynamic system is subjected to a plurality of disturbances, which are inputs to the dynamic system that may have an undesirable effect on the output(s) of the system.

Currently, most system regulator or controller designs either neglect the effect of the disturbance, design ad-hoc or heuristic logic schemes such as kickers and gain modifiers, or design feed-forward controllers based on steady state relationships to account for the disturbance effect. Most of the ad-hoc designs account for only small changes in the disturbance or assume a fixed relationship for the disturbances. There is need for disturbance rejection that can account for the more diverse disturbances and generally be a more dynamic disturbance rejection system.

### BRIEF DESCRIPTION OF THE INVENTION

In one aspect, a method for reducing an effect of a disturbance signal on an output of a dynamic system is described.

One method for processing a compensated control signal for reducing disturbance effects on a dynamic system, comprises receiving at least one input command signal, obtaining state information about the system, processing at least one disturbance signal, and computing a feedthru gain, a feedback gain, and a feedforward gain. The feedthru gain is computed from the command signal, the feedback gain is computed from the state information, and the feedforward gain is computed from the disturbance signal, wherein each is computed using inverse system dynamics. The compensated control signal is processed using at least one of the feedthru gain, the feedback gain, and the feedforward gain wherein the compensated control signal is then transmitted to the dynamic system.

In certain aspects, such as for a steady state condition, the processing of the compensated control signal uses only the feedforward gain and the feedback gain. There should be no change in the control signal and/or the feedthru output can be set to zero or otherwise removed from the processing.

In one embodiment, the disturbance signal is from at least one of a measured system disturbance and an estimated system disturbance. In addition, computing of the feedforward gain, feedback gain or feedthru gain can be online processing, offline processing, scheduled processing, and/or adaptive online processing.

One embodiment for computing the feedforward gain comprises calculating a difference between two sampled disturbance values during consecutive sampling periods and generating a disturbance signal increment, wherein the disturbance signal increment is used in computing of the feedforward gain.

The state information in certain aspects can be obtained from at least one of a measured state value and an estimated state value. This includes multiple measured and/or state values in the state information.

The computing of the feedthru gain, the feedback gain and the feedforward gain, in one aspect, each comprises computing linear models and generating a respective feedthru gain matrix, a feedback gain matrix and a feedforward gain matrix. The linear models can use at least one of transfer functions, state space models, and analytic models.

In one embodiment the compensated control signal is processed according to uₖ=uₖ₋₁+K₁\tilde{v}ₖ+K₃Fₖ+K_{d}\tilde{d}ₖ, wherein K₁ is the feedthru gain, K₃ is the feedback gain, and K_{d} is the feedforward gain. In another embodiment the compensated control signal is processed according to uₖ=uₖ₋₁+K₅\tilde{v}ₖ+K₇Fₖ+Kₑ\tilde{d}ₖ, wherein K₅ is the feedthru gain, K₇ is the feedback gain, and Kₑ is the feedforward gain.

In accordance with one aspect a dynamic disturbance rejection device reduces an effect of a disturbance signal on an output of a controlled system. The device comprises at least one input command signal wherein the command signal effects one or more parameters of the controlled system. There is a feedback section with state information about the controlled system, wherein the feedback section generates a feedback gain output using inverse system dynamics. There is a feedforward section with disturbance information, wherein the feedforward section generates a feedforward output using inverse system dynamics. There is also a feedthru section coupled to the command signal, wherein the feedforward section generates a feedforward output using inverse system dynamics. A processing unit is coupled to the feedthru section, the feedback section and the feedforward section, wherein the processing unit processes a compensated control signal for the controlled system from the feedthru output, the feedback output and the feedforward output. The processing unit can be any form of processing capability and the coupling can be operatively coupled or otherwise allowing for the data transfer. The device according to one implementation comprises at least subtractors, adders, and multipliers.

The device, according to one aspect, further comprising one or more sensors coupled to the controlled system, wherein the sensors provide the state information and the disturbance information.

The feedback section in one embodiment is a full state feedback controller.

One embodiment for a system for reducing disturbance effects on a dynamic apparatus, comprises receiving at least one of command inputs, state feedback, and disturbance values, calculating an incremental disturbance by subtracting a past disturbance value from a current disturbance value, processing a feedback gain matrix, a feedforward gain matrix, and a feedthru gain matrix by inverse system dynamics. A feedforward output is produced by multiplying the incremental disturbance by the feedforward gain matrix. A feedback output is produced by multiplying the state feedback by the feedback gain matrix. A feedthru output is produced by multiplying the command inputs by the feedthru gain matrix. The feedthru output, feedback output, and feedforward output are processed to generate a compensated control signal, wherein the compensated control signal is transmitted to the dynamic apparatus.

One aspect of the dynamic apparatus is that is can be a single-input-single-output, multiple-input-multiple-output, single-input-multiple-output, or multiple-input-single-output.

### BRIEF DESCRIPTION OF THE DRAWINGS

FIG. 1 is a block diagram of an exemplary system for reducing an effect of a disturbance.

FIG. 2 is a block diagram of an exemplary dynamic system that may be used with the system shown in FIG. 1.

FIG. 3 is a block diagram of an exemplary embodiment of a disturbance rejection system (DDRS) that may be used with the system shown in FIG. 1.

FIG. 4 shows an embodiment of a plurality of plots that show disturbance magnitude versus time.

FIG. 5 shows a plurality of exemplary graphs that show the ratio of the disturbance magnitude versus time from the plots of FIG. 4.

FIG. 6 is a block diagram of an exemplary dynamic disturbance rejection system (DDRS) that may be used with the system shown in FIG. 1.

FIG. 7 is a block diagram of an alternative embodiment of a DDRS, which may be used with the system shown in FIG. 1.

FIG. 8 illustrates a plurality of graphs showing system response of basic control without disturbances.

FIG. 9 illustrates a plurality of graphs showing system response with disturbances in the system without implementing the DDRS.

FIG. 10 illustrates a plurality of graphs illustrating system response with disturbances and the reduction of the effects of disturbances using the DDRS in accordance with one embodiment.

FIG. 11 is a flow chart illustrating features of the DDRS according to one embodiment.

### DETAILED DESCRIPTION

According to one embodiment, the system provides for reducing or eliminating the impact of disturbances to dynamic systems. More specifically, the systems and methods describe rejecting or attenuating the influence of measured or estimated system disturbances on system output(s).

There are many systems that incorporate some form of control theory across many industries, such as aerospace, marine, automotive, paper, plastics, food, and pharmaceutical, and across many disciplines such as mechanical, chemical, electrical, and magnetic. These controlled systems can have single or multiple control inputs as well as single or multiple regulated or controlled outputs. According to one embodiment, it is desired to regulate or control one or more of the system or process outputs by using one or more of the system control inputs. The signals used to regulate or control the process outputs of the dynamic system are called control inputs. Inputs other than the control inputs that may have an effect on or disturb the controlled outputs are disturbances to the system. When the disturbance inputs change value or vary, they tend to move the controlled output away from the desired or tracked value. This disturbance may, for example, reduce the steady state and transient performance, stability, speed of response, accuracy, and/or efficiency of the system or process.

In some aspects, this technique attenuates or cancels the influence of the disturbance input(s) on the desired output(s). One benefit of the dynamic disturbance rejection is an increased tracking or regulation performance for the systems including combinations of single-input-single-output (SISO), multiple-input-multiple-output (MIMO), as well as hybrid cases of single-input-multiple-output (SIMO) and multiple-input-single-output (MISO). There may be single or multiple disturbance input signals to the system in each of these embodiments.

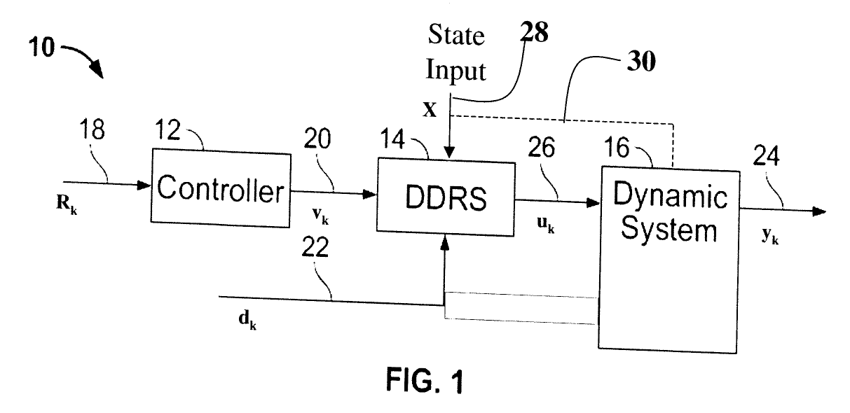

FIG. 1 is a basic block diagram of one embodiment of the system 10 that may be used to facilitate reducing an effect of a disturbance. In this embodiment, system 10 includes a controller 12, a dynamic disturbance reduction system (DDRS) 14, and a dynamic system 16. As used herein, the term controller refers to any form of software and/or hardware, which includes processing capabilities such as, used in a computer, a processor, a microcontroller, a microcomputer, a programmable logic controller, an application specific integrated circuit, and other programmable circuits. In one embodiment the controller is software that resides on one of the hardware platforms.

The DDRS 14 also includes processing capabilities such as those in a controller, a computer, a processor, a microcontroller, a microcomputer, a programmable logic controller, an application specific integrated circuit, and other programmable circuits.

In general, the dynamic system 16 a physical machine, device or assembly that can change its operating conditions or state based on changes to inputs to the system. Some examples of a dynamic system 16 includes, but is not limited to, an engine, such as, an internal combustion engine, a diesel engine, or a gas turbine used in power plants or alternatively aircraft propulsion, and vehicles. Examples of vehicles include at least car, airplanes, trucks, and motorcycles. The dynamic system can also be assemblies or subassemblies such as a fuel tank or water tank of an engine, such that there may be multiple dynamic systems integrally operating on a larger system.

By way of further example, the dynamic system 16 can be employed in various types of control systems that incorporate any number of elements such electrical devices, mechanical devices, electro-mechanical devices, magnetic devices and/or a chemical substances. The dynamic system 16 may be implemented in, but is not limited to being implemented in various industries such as aerospace industry, marine industry, paper industry, automotive industry, plastic industry, food industry, and/or pharmaceutical industry.

Referring again to FIG. 1, dynamic system 16 can be a single-input-single-output (SISO) system, a multiple-input-multiple-output (MIMO) system, and combinations thereof such as single-input-multiple-outputs and multiple-inputs-single-output. This includes both continuous and discrete signals processed by the system. It should be noted that the reference to input and output in this manner is with respect to compensated control signal(s) 26 (uₖ) to the dynamic system 16 and the regulated output(s) 24 (yₖ) from the dynamic system 16. This is independent of the single or multiple disturbance signals 22. As shown, the compensated control signals 26 (uₖ) can be a single input or multiple input control signals to the system 16. The compensated control signals 26 are typically discrete time representations and not continuous values as typically utilized by the dynamic system 16. Likewise, the output signal 24 (yₖ) can be a single regulated output or multiple regulated outputs from the system 16. The output signals 24 are also typically discrete time representations and not continuous values of the larger system 16. One embodiment operates using certain continuous signals that are then processed into discrete time signals for processing by the DDRS 14.

According to one embodiment, controller 12 receives a discrete controller input signal 18 (Rₖ) that may come from a supervisory system, such as a person or supervisory computer. The discrete controller input signal 18 can be via an input device or some processed signal that may depend upon other variables. Controller 12 receives the discrete controller input signal 18 (Rₖ), which is a signal in a discrete time domain, and processes the signal 18 to output a processed command signal or discrete controller output signal 20 or vₖ, which is also a signal in the discrete time domain. The variable k is an integer. Each value of k represents a sampling period tₛ described below. For example, k=1 represents a first sampling period and k=2 represents a second sampling period. In another embodiment, there is no controller 12 and the command signal 20 is a direct input to the DDRS 14. As used herein, the term command signals 20 shall refer to those discrete controller input signal 18 processed by the controller 12 and to other command signals without controller 12 processing.

In one aspect, controller 12 receives controller input signal 18 from a person via an input device, or from a supervisory computer across a communication device, or from a supervisory algorithm in-situ with the discrete controller 12. An example of the input device includes a mouse, keyboard, or any other analog or digital communication device. An example of a process performed by controller 12 on discrete controller input signals 18 include integration, filtering, and/or determining a rate of change of information for the discrete controller input signal 18. The command signal 20 may itself be part of a control system that incorporates some other feedback and sensor processing.

One example of discrete controller input signal 18 includes a signal representative of a thrust demand, which is an amount of thrust, of a propulsion system and a power demand, which is an amount of power, of a power plant. Other examples of discrete controller input signal 18 include a signal representative of a rate of change of an altitude and a rate of change of speed. Examples of command signals 20 include a signal representative of a rate of the thrust demand, a rate of change of the power demand, a rate of change of fuel flow, and a rate of change of an exhaust nozzle area.

The command signal 20 (vₖ) in one aspect is a processed discrete controller input signal 18 that takes into account the parameters or features about the system. In a further embodiment, the controller 12 is not a separate unit but rather a separate function that performs some processing on the discrete controller input signal 18. In another embodiment, the command signal 20 is independent of the controller 12.

In this embodiment, DDRS 14 receives command signal 20 and discrete disturbance signal 22 or dₖ, which is a signal in the discrete time domain. As noted herein, the reference to a disturbance signal 22 can represent a single disturbance signal or multiple disturbance signals.

The DDRS 14 also receives some state input 28 that can be a single state signal or multiple state signals. The DDRS 14 reduces an effect of the disturbance signal 22 on the dynamic system output signal 24 or yₖ, by generating a DDRS output signal 26 or compensated control signal uₖ.

DDRS 14 processes the one or more command signals 20, the one or more state input signals 28, along with the one or more disturbance signals 22 using various feedthru, feedback and feedforward processing techniques detailed herein. The feedthru, feedback and feedforward processing is accomplished by inverse system dynamics. In a general sense, inverse system dynamics refers to a technique for the estimation of structural input forces. In one time domain example, a non-causal inverse structural filter uses input data and response data to estimate input forces. This technique allows pseudo-real-time estimation of input forces for non-collocated sensor/actuator pairs for multi-input/multi-output systems. The term “inverse” refers to the fact that the roles of input and output are reversed from the usual forward system structural dynamics problem. An advantage of this approach is that it typically only requires measured response data.

The processing typically requires some knowledge about the dynamic system 16, which in one embodiment is state information 28 that allows for the DDRS to alter the command signals 20 using the disturbance signals 22 in order to generate the compensated control signals 26. In one aspect, the state input 28 is updated continuously based upon measurements or estimates to reflect the current condition of the system. In another aspect, the state input 28 is obtained from the dynamic system 16 wherein the measured or sensed system information 30 is used by the DDRS 14.

State information can be generally described as the current operational system condition. For example, state information for an energy storing system of a flywheel can be described by its current rotational velocity. Examples of discrete dynamic system output signal 24 include a signal representative of an engine pressure ratio (EPR) across an engine within dynamic system 16, a thrust output by dynamic system 16, a speed of dynamic system 16, a power of dynamic system 16, and/or an increase or decrease in a level of fluid within a fluid tank. Examples of discrete disturbance signal 22 include a signal representative of a flow of air, a flow of fuel, a flow of water, or a flow of chemical into dynamic system 16, at least one environmental ambient condition, such as humidity or condensation, due to weather or an operating condition surrounding dynamic system 16, a temperature or alternatively pressure of the atmosphere surrounding dynamic system 16, a flow of energy from an actuator or alternatively an effector into dynamic system 16, and/or a variable geometry, such as a plurality of variable stator vanes, a plurality of variable guide vanes, a plurality of variable by-pass ratios, which change basic physical relationships in dynamic system 16.

According to one embodiment, a sensor, such as a position sensor, a flow sensor, a temperature sensor or a pressure sensor, measures a parameter, such as a position, a flow, a temperature or alternatively a pressure, of a sub-system, such as a tire or an engine, within dynamic system 16 may be used to generate discrete disturbance signal 22. Alternatively, discrete disturbance signal 22 can be estimated or calculated by an estimation algorithm executed by a controller. For example, discrete disturbance signal 22 can be a temperature calculated or estimated, by the estimation algorithm and the estimation algorithm calculates or estimates the temperature by using information from one or a combination of sensors including a speed sensor, a pressure sensor that senses a pressure at a location within or alternatively outside dynamic system 16, and a plurality of temperatures sensors that sense temperatures at a plurality of locations in dynamic system 16. It is noted that in an alternative embodiment, at least one of controller 12 and DDRS 14 are coupled to a memory device, such as a random access memory (RAM) or a read-only memory (ROM), and an output device, such as a display, which can be a liquid crystal display (LCD) or a cathode ray tube (CRT). This allows for a visual display of the system dynamics to a user and may include manual control of certain parameters.

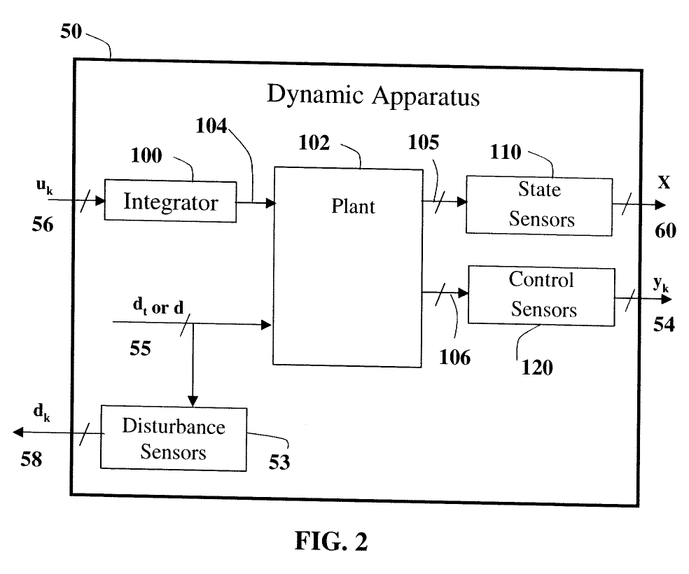

FIG. 2 is a block diagram of a dynamic apparatus 50, which is another example of dynamic system 16. In one embodiment, the dynamic apparatus 50 is a Multiple-Input Multiple-Output (MIMO) apparatus that receives one or more compensated control signals 56 from the DDRS 14, and generates a plurality of dynamic apparatus output signals 54. In other embodiments, the apparatus 50 can be a single-input-single-output (SISO) apparatus, a multiple-input-multiple-output (MIMO) apparatus, and any combination thereof. It should be understood that the dynamic apparatus 50 typically operates in a continuous real time mode in certain embodiments whereas typically the DDRS (not shown) typically operates with discrete signals.

Dynamic apparatus 50 in this example includes an integrator 100 and a plant 102. An example of plant 102 includes an engine, such as a turbine engine or a car engine, and/or an electronic commutated motor. Integrator 100 receives and integrates discrete DDRS output signal 56 to generate an integrator output signal 104. Plant 102 receives the integrator output signal 104 and generates the plant output signals 105, 106 based on integrator output signal 104 and disturbances 55. For example, a turbine engine outputs thrust based on a signal representing an amount of fuel flow to the turbine engine and based on its environmental operating conditions. As another example, a vehicle engine outputs rotations per minute (RPM) of a vehicle based on a signal representing an amount of fuel flowing to the vehicle engine and the conditions in which the vehicle is operating.

The disturbances 55 in one example reflect conditions or circumstances that would affect the dynamic apparatus 50 operations if not accounted for by the compensated control signals 56 from the DDRS 14. For example, there could be servo system that incorporates various actuators, switches, and other control devices that assist in the functionality of the dynamic system.

In one embodiment the disturbance 55 is coupled to one or more disturbance sensors 53 that generate the disturbance signals 58 used by the DDRS 14 of FIG. 1. There can one or more sensors 53 coupled to the disturbance 55 within the dynamic system 16.

The apparatus 50 can receive a single or plurality of dynamic apparatus disturbances 55. In one embodiment each dynamic apparatus input signal 56 is an example of DDRS compensated control signal 26 (shown in FIG. 1). Moreover, each dynamic apparatus disturbance signal 58 can be an example of disturbance signal 22 (shown in FIG. 1). Each discrete dynamic apparatus output signal 54 can be an example of dynamic system output signal 24. The output 60 from the state sensors 110 can be an example of the state input signals 28, 30 of FIG. 1. It is noted that in a one embodiment, dynamic apparatus 50 receives any number of dynamic apparatus input signals 56, and outputs any number of dynamic apparatus output signals 54 and are influenced by one or more dynamic apparatus disturbances 55. The DDRS processes the compensated control signals 56 by processing the disturbance signals 58 along with state information 60.

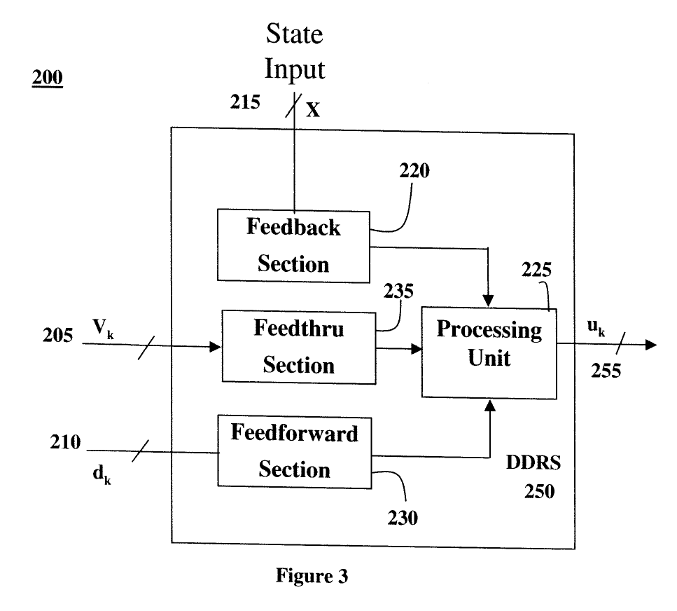

Referring to FIG. 3, one embodiment of a DDRS 250 is shown for a compensated control processing system 200. There are one or more input command signals 205 to the DDRS 250 along with one or more disturbance signals 210. The DDRS 250 includes a feedback section 220, a feedforward section 230, a feedthru section 235 along with some form of processing section 225 that processes the one or more compensated output control signals 255. While illustrated as separate sections for convenience, such implementations can be co-located and integrated.

The feedback section 220 uses state input information 215 in order to utilize information about the system to calculate the feedback gain using inverse system dynamics and also the system response to the compensated control signals 255. The feedback section 220 can produce estimated values such as by using lookup tables, it can process calculated values based on formulae, it can used sensed measurements or values, and any combination thereof. According to one embodiment, the feedback section 220 is a dynamic feedback based inversion controller that uses inverse system dynamics processing.

The feedforward section 230 uses the disturbance signals 210 to provide an indication of factors that may affect the system performance unless otherwise compensated for in the DDRS 250. According to one embodiment, the feedforward section uses inverse system dynamics processing to calculate the feedforward gain. According to one embodiment, the feedforward section is a dynamic feedforward based inversion controller that uses inverse system dynamics processing.

The feedthru section 235 processes the input command signals 205 (Vₖ) and once again uses inverse system dynamics processing in one embodiment to compute the feedthru gain. In a steady state condition or one in which the dynamic system would be static, the DDRS would operate without using the feedthru section 235 outputs.

According to one embodiment, the DDRS processing section 225 uses the feedforward gain, the feedback gain, and the feedthru gain to alter the command input signals 205 into the compensated control signals 255 that account for the disturbance effects.

While depicted as separate items, the feedback section 220, feedforward section 230, feedthru section 235 and processing unit 225 can be integrated or disparate depending upon the design criteria. Similarly, while the DDRS is shown as a separate and distinct unit, it can be integrated with the dynamic system.

For illustrative purposes, the DDRS describes or models the dynamic system as a set of continuous time nonlinear equations that may be represented as follows:

\dot{x}ₜ=ƒ(xₜ,uₜ,dₜ) (1)

yₜ=h(xₜ,uₜ,dₜ) (2)

where xₜ is a state of the system, such as a level of fluid within the fluid tank, an engine speed, or an engine temperature, t is continuous time, \dot{x}ₜ is a derivative, with respect to the time t, of the state xₜ, uₜ is a DDRS output signal, which is a continuous form of the discrete DDRS output signal uₖ, dₜ is a disturbance signal, which is a continuous form of the discrete disturbance signal dₖ, and yₜ is a dynamic system output signal, which is a continuous form of the discrete dynamic system output signal yₖ. For example, uₖ is generated by sampling uₜ, dₖ is generated by sampling dₜ, and yₖ is generated by sampling yₜ. In one embodiment, f and h is each a nonlinear function. An example of the state xₜ is a temperature of the turbine engine and/or a temperature of the car engine. Other examples of the state xₜ include a speed of a rotating mass, a pressure, an amount of heat, an amount of potential energy, and/or an amount of kinetic energy contained in an energy storing element or device located within dynamic system. The state information can be sensed or measured and can also be estimated or theoretically derived based on certain state information.

The DDRS defines a nominal state value x̅ₜ, which is a particular value of the state xₜ at a reference time and defines an incremental state variable \tilde{x}ₜ for the state xₜ as:

xₜ= x̅ₜ+\tilde{x}ₜ. (3)

where \tilde{x}ₜ is an increment to the nominal state value x̅ₜ. Similarly, the DDRS defines a nominal input value ūₜ, which is a particular value at the reference time of the DDRS output signal uₜ and defines an incremental input variable ũₜ for the DDRS output signal uₜ as

uₜ=ūₜ+ũₜ. (4)

where ũₜ is an increment to the nominal input value ūₜ. Moreover, the DDRS defines a nominal output value, which is a particular value at the reference time of the dynamic system output signal yₜ, and defines an incremental output variable \tilde{y}ₜ for dynamic system output signal yₜ as:

yₜ= y̅ₜ+\tilde{y}ₜ. (5)

where \tilde{y}ₜ is an increment to the nominal output value y̅ₜ. Additionally, DDRS defines a nominal disturbance value d̅ₜ, which is a particular value at the reference time of the disturbance signal dₜ, and defines an incremental disturbance variable \tilde{d}ₜ for disturbance signal dₜ as:

dₜ= d̅ₜ+\tilde{d}ₜ. (6)

where \tilde{d}ₜ is an increment to the nominal disturbance value d̅ₜ.

The DDRS linearizes the function f represented by equation (1) by applying:

$${\dot{x}}_{t} = {\dot{\overline{x}}}_{t} + {\dot{\tilde{x}}}_{t} = f ( {\overline{x}}_{t} , {\overline{u}}_{t} , {\overline{d}}_{t} ) + \frac{\partial f}{\partial {x}_{t}} {\vert}_{{\overline{x}}_{t} , {\overline{d}}_{t} , {\overline{u}}_{t}} {\tilde{x}}_{t} + \frac{\partial f}{\partial {u}_{t}} {\vert}_{{\overline{x}}_{t} , {\overline{d}}_{t} , {\overline{u}}_{t}} {\tilde{u}}_{t} + \frac{\partial f}{\partial {d}_{t}} {\vert}_{{\overline{x}}_{t} , {\overline{d}}_{t} , {\overline{u}}_{t}} {\tilde{d}}_{t} \qquad ( 7 )$$

where \dot{x}ₜ is a derivative, with respect to time t, of the state xₜ, \overline{\dot{x}}ₜ is a derivative, with respect to time t, of the nominal state value x̅ₜ, \tilde{\dot{x}}ₜ is a derivative, with respect to time t, of the incremental state variable

$${\tilde{x}}_{t} , \frac{\partial f}{\partial {x}_{t}} {\vert}_{{\overline{x}}_{t} , {\overline{d}}_{t} , {\overline{u}}_{t}}$$

is a partial derivative of the function f, with respect to xₜ and is evaluated at x̅ₜ, d̅ₜ, and ūₜ.

$$\frac{\partial f}{\partial {u}_{t}} {\vert}_{{\overline{x}}_{t} , {\overline{d}}_{t} , {\overline{u}}_{t}}$$

is a partial derivative of the function f, with respect to uₜ and is evaluated at x̅ₜ, d̅ₜ, and ūₜ, and

$$\frac{\partial f}{\partial {d}_{t}} {\vert}_{{\overline{x}}_{t} , {\overline{d}}_{t} , {\overline{u}}_{t}}$$

is a partial derivative of the function f, with respect to dₜ and is evaluated at x̅ₜ, d̅ₜ, and ūₜ.

Moreover, the DDRS expands the function h represented by equation (2) by applying:

$${y}_{t} = {\overline{y}}_{t} + {\tilde{y}}_{t} = h ( {\overline{x}}_{t} , {\overline{u}}_{t} , {\overline{d}}_{t} ) + \frac{\partial h}{\partial {x}_{t}} {\vert}_{{\overline{x}}_{t} , {\overline{d}}_{t} , {\overline{u}}_{t}} {\tilde{x}}_{t} + \frac{\partial h}{\partial {u}_{t}} {\vert}_{{\overline{x}}_{t} , {\overline{d}}_{t} , {\overline{u}}_{t}} {\tilde{u}}_{t} + \frac{\partial h}{\partial {d}_{t}} {\vert}_{{\overline{x}}_{t} , {\overline{d}}_{t} , {\overline{u}}_{t}} {\tilde{d}}_{t} \qquad ( 8 )$$

where

$$\frac{\partial h}{\partial {x}_{t}} {\vert}_{{\overline{x}}_{t} , {\overline{d}}_{t} , {\overline{u}}_{t}}$$

is a partial derivative of the function h, with respect to xₜ and is evaluated at x̅ₜ, d̅ₜ, and ūₜ,

$$\frac{\partial h}{\partial {u}_{t}} {\vert}_{{\overline{x}}_{t} , {\overline{d}}_{t} , {\overline{u}}_{t}}$$

is a partial derivative of the function h, with respect to uₜ and is evaluated at x̅ₜ, d̅ₜ, and ūₜ, and

$$\frac{\partial h}{\partial {d}_{t}} {\vert}_{{\overline{x}}_{t} , {\overline{d}}_{t} , {\overline{u}}_{t}}$$

is a partial derivative of the function h, with respect to dₜ and is evaluated at x̅ₜ, d̅ₜ, and ūₜ.

The DDRS represents a change in the state xₜ as a function of a change in the DDRS output signal uₜ and a change in the disturbance signal dₜ by representing the derivative \tilde{\dot{x}}ₜ of the incremental state variable \tilde{x}ₜ as a function of the incremental disturbance variable \tilde{d}ₜ and a function of the incremental input variable ũₜ as:

$${\dot{\tilde{x}}}_{t} = f ( {\overline{x}}_{t} , {\overline{u}}_{t} , {\overline{d}}_{t} ) + \frac{\partial f}{\partial {x}_{t}} {\vert}_{{ }_{{\overline{x}}_{t} , {\overline{d}}_{t} , {\overline{u}}_{t}}} {\tilde{x}}_{t} + \frac{\partial f}{\partial {u}_{t}} {\vert}_{{\overline{x}}_{t} , {\overline{d}}_{t} , {\overline{u}}_{t}} {\tilde{u}}_{t} + \frac{\partial f}{\partial {d}_{t}} {\vert}_{{\overline{x}}_{t} , {\overline{d}}_{t} , {\overline{u}}_{t}} {\tilde{d}}_{t} - {\dot{\overline{x}}}_{t} \qquad ( 9 )$$

The DDRS derives equation (9) by making \tilde{\dot{x}}ₜ the subject of equation (7). Moreover, the DDRS represents a change in the dynamic system output signal yₜ as a function of a change in the DDRS output signal uₜ and a change in the disturbance signal dₜ by representing the incremental output variable \tilde{y}ₜ as a function of the incremental disturbance variable \tilde{d}ₜ and a function of the incremental input variable ũₜ as:

$${\tilde{y}}_{t} = h ( {\overline{x}}_{t} , {\overline{u}}_{t} , {\overline{d}}_{t} ) + \frac{\partial h}{\partial {x}_{t}} {\vert}_{{\overline{x}}_{t} , {\overline{d}}_{t} , {\overline{u}}_{t}} {\tilde{x}}_{t} + \frac{\partial h}{\partial {u}_{t}} {\vert}_{{\overline{x}}_{t} , {\overline{d}}_{t} , {\overline{u}}_{t}} {\tilde{u}}_{t} + \frac{\partial h}{\partial {d}_{t}} {\vert}_{{\overline{x}}_{t} , {\overline{d}}_{t} , {\overline{u}}_{t}} {\tilde{d}}_{t} - {\overline{y}}_{t} \qquad ( 10 )$$

The DDRS derives equation (10) by making \tilde{y}ₜ the subject of equation (8).

The DDRS substitutes \overline{\dot{x}}ₜ=ƒ( x̅ₜ,ūₜ, d̅ₜ)=0, substitutes A_{c} instead of

$$\frac{\partial f}{\partial {x}_{t}} {\vert}_{{\overline{x}}_{t} , {\overline{d}}_{t} , {\overline{u}}_{t}} ,$$

substitutes B_{cu} instead of

$$\frac{\partial f}{\partial {u}_{t}} {\vert}_{{\overline{x}}_{t} , {\overline{d}}_{t} , {\overline{u}}_{t}} ,$$

and B_{cd} instead of

$$\frac{\partial f}{\partial {d}_{t}} {\vert}_{{\overline{x}}_{t} , {\overline{d}}_{t} , {\overline{u}}_{t}}$$

in equation (9) to generate:

\tilde{\dot{x}}ₜ=A_{c}\tilde{x}ₜ+B_{cu}ũₜ+B_{cd}\tilde{d}ₜ+ƒ (11)

It is noted that \overline{\dot{x}}ₜ=0 when x̅ₜ is a constant, an equilibrium solution, or a steady state of the portion of dynamic system. When x̅ₜ is a constant, regardless of the time t, ƒ( x̅ₜ,ūₜ, d̅ₜ) is also a constant regardless of the time t of evolution of representation of dynamic system. The DDRS derives y̅ₜ from equation (2) by applying:

y̅ₜ=h( x̅ₜ,ūₜ, d̅ₜ) (12)

Moreover, the DDRS substitutes y̅ₜ instead of h( x̅ₜ,ūₜ, d̅ₜ), a matrix C instead of

$$\frac{\partial h}{\partial {x}_{t}} {\vert}_{{\overline{x}}_{t} , {\overline{d}}_{t} , {\overline{u}}_{t}} ,$$

a matrix Dᵤ instead of

$$\frac{\partial h}{\partial {u}_{t}} {\vert}_{{\overline{x}}_{t} , {\overline{d}}_{t} , {\overline{u}}_{t}} ,$$

and a matrix D_{d} instead of

$$\frac{\partial h}{\partial {d}_{t}} {\vert}_{{\overline{x}}_{t} , {\overline{d}}_{t} , {\overline{u}}_{t}}$$

in equation (10) to generate:

\tilde{y}ₜ=C\tilde{x}ₜ+Dᵤũₜ+D_{d}\tilde{d}ₜ (13)

The DDRS generates a discrete time model of equation (11) by substituting \tilde{x}ₖ instead of \tilde{x}ₜ, ũₖ instead of ũₜ, \tilde{d}ₖ instead of \tilde{d}ₜ to generate:

\tilde{x}ₖ₊₁=A\tilde{x}ₖ+Bᵤũₖ+B_{d}\tilde{d}ₖ+Fₖ (14)

where the DDRS calculates a matrix A as being equal to I+A_{c}tₛ, calculates a matrix Bᵤ to be equal to B_{cu}tₛ, a matrix B_{d} to be equal to B_{cd}tₛ, Fₖ to be equal to ƒ( x̅ₜ,ūₜ, d̅ₜ)tₛ, \tilde{x}ₖ, an incremental discrete state, to be equal to a discrete form of \tilde{x}ₜ, ũₖ, an incremental discrete DDRS output signal, to be equal to a discrete form of ũₜ, and \tilde{d}ₖ, an incremental discrete disturbance signal, to be a discrete form of \tilde{d}ₜ, tₛ is a sampling time or the sampling period, I is an identity matrix, and \tilde{x}ₖ₊₁ is an incremental discrete state. Moreover \tilde{x}ₖ₊₁ of equation (14) can also be represented as a difference between a discrete state xₖ₊₁ and xₖ, where xₖ₊₁ is a discrete state of the portion of the dynamic system sampled during a sampling period k+1 and is generated one sampling period after xₖ is generated, and \tilde{x}ₖ is the incremental discrete state. A microprocessor or a controller samples xₖ from xₜ with the sampling period tₛ, samples yₖ from yₜ with the sampling period tₛ, samples uₖ from uₜ with the sampling period tₛ, and samples dₖ from dₜ with the sampling period tₛ. It is noted that dₖ, uₖ, xₖ, and yₖ are samples that are sampled at the same time or during the same sampling period k.

Furthermore, the DDRS generates a discrete time model of equation (13) by substituting \tilde{x}ₖ instead of \tilde{x}ₜ, ũₖ instead of ũₜ, and \tilde{d}ₖ instead of \tilde{d}ₜ in equation (13) to generate:

\tilde{y}ₖ=C\tilde{x}ₖ+Dᵤũₖ+D_{d}\tilde{d}ₖ (15)

where \tilde{y}ₖ is an incremental discrete dynamic system output signal of the dynamic system, where \tilde{y}ₖ is represented by a discrete form, yₖ= y̅ₖ+\tilde{y}ₖ, of the definition as provided in equation (5). If the dynamic system is a relative degree one system, the DDRS formulates a desired response of dynamic system as being a first order desired response. The relative degree one system takes one sample period to change an output of dynamic system based on an input to dynamic system. For example, when an input to dynamic system is uₖ, the relative degree one system outputs yₖ₊₁, which is a dynamic system output signal that is output from dynamic system one sample period after yₖ is output from the dynamic system. The DDRS generates equations (16)-(25) based on the relative degree one system. A method similar to that of deriving equations (16)-(25) can be used to derive a plurality of equations for a dynamic system of any relative degree, such as degrees two thru twenty. One form of the first order desired response is an integrator which can be written as follows:

\tilde{y}ₖ₊₁−\tilde{y}ₖ=tₛ\tilde{v}ₖ (16)

where \tilde{y}ₖ₊₁ is a future incremental discrete dynamic system output from the dynamic system one sample after the current sample \tilde{y}ₖ is output from the dynamic system, \tilde{v}ₖ is an incremental discrete controller output signal obtained as a difference between the discrete controller output signal vₖ and a nominal discrete controller output signal v̅ₖ, which is a particular value of the discrete controller output signal vₖ at the reference time. The relative degree one dynamic system is an example of the dynamic system 16.

The DDRS generates \tilde{y}ₖ₊₁ from equation (15) as:

\tilde{y}ₖ₊₁=C\tilde{x}ₖ₊₁+Dᵤũₖ₊₁+D_{d}\tilde{d}ₖ₊₁ (17)

where \tilde{d}ₖ₊₁ can also be represented as a difference between dₖ₊₁ and dₖ, where dₖ₊₁ is a discrete disturbance signal input to dynamic system during a sampling period k+1, and is generated one sampling period after dₖ is generated, and ũₖ₊₁ can also be represented as a difference between uₖ₊₁ and uₖ, where uₖ₊₁ is a discrete DDRS output signal output by the DDRS during a sampling period k+1, and is generated one sampling period after uₖ is generated. The DDRS substitutes \tilde{x}ₖ₊₁ from equation (14) and Dᵤ=0 for the relative degree one system into equation (17) to generate:

\tilde{y}ₖ₊₁=CA\tilde{x}ₖ+CBᵤũₖ+CB_{d}\tilde{d}ₖ+CFₖ+D_{d}\tilde{d}ₖ₊₁ (18)

The DDRS further substitutes Dᵤ=0 and equations (15) and (18) into the first desired response, represented by equation (16), to generate:

CA\tilde{x}ₖ+CBᵤũₖ+CB_{d}\tilde{d}ₖ+D_{d}\tilde{d}ₖ₊₁+CFₖ−C\tilde{x}ₖ−D_{d}\tilde{d}ₖ=st\tilde{v}ₖ (19)

The DDRS solves for ũₖ as

ũₖ=|CBᵤ|⁻¹{tₛ\tilde{v}ₖ+(C−CA)\tilde{x}ₖ+(D_{d}−CB_{d})\tilde{d}ₖ−D_{d}\tilde{d}ₖ₊₁−CFₖ} (20)

The DDRS defines xₖ= x̅ₖ within a relationship:

xₖ= x̅ₖ+\tilde{x}ₖ (21)

to generate

\tilde{x}ₖ=0 (22)

where x̅ₖ is a nominal discrete state value, which is a particular value at the reference time of the discrete state xₖ. Equation (21) is a discrete form of the relation expressed by equation (3).

The DDRS substitutes 2\tilde{d}ₖ instead of \tilde{d}ₖ₊₁ in equation (20) and substitutes equation (22) into equation (20) to generate:

ũₖ=|CBᵤ|⁻¹{tₛ\tilde{v}ₖ−CFₖ+(−D_{d}−CB_{d})\tilde{d}ₖ} (23)

The DDRS generates the discrete DDRS output signal uₖ as being:

uₖ=uₖ₋₁+ũₖ (24)

where uₖ₋₁ is a discrete DDRS output signal output by the DDRS at k−1 and generated one sampling period before uₖ is output by the DDRS, and ũₖ is a discrete form in the discrete time domain of ũₜ. The DDRS substitutes equation (23) into equation (24), substitutes K₁ instead of |CBᵤ|⁻¹tₛ in equation (24), K₃ instead of −|CBᵤ|⁻¹C in equation (24), and K_{d} instead of |CBᵤ|⁻¹(−D_{d}−CB_{d}) in equation (24) to generate:

uₖ=uₖ₋₁+K₁\tilde{v}ₖ+K₃Fₖ+K_{d}\tilde{d}ₖ (25)

The DDRS computes K_{d} at least one of before and during energization of the dynamic system. For example, the DDRS computes K_{d} on-line in real time while the dynamic system is being operated by a power source. As another example, the DDRS computes K_{d} off-line before the dynamic system is provided power by the power source. The DDRS changes uₖ at the same time the disturbance signal dₜ is input to the dynamic system. Accordingly, an impact of the disturbance signal dₜ on the dynamic system is reduced. It should be understood that the equations are for illustrative purposes of an example for the processing of uₖ and other inverse system dynamic formulations can be used for processing.

As an alternative to formulating the first desired response, the DDRS formulates one form of a second order desired response as:

\tilde{y}ₖ₊₂−(1+α)\tilde{y}ₖ₊₁+α\tilde{y}ₖ=(1−α)tₛ\tilde{v}ₖ (26)

where

$$α = ( 1 - \frac{ts}{τ} ) ,$$

τ is a time constant of the dynamic system, \tilde{y}ₖ₊₂ is an incremental discrete dynamic system output signal, and \tilde{y}ₖ₊₂ can also be represented as a difference between a dynamic system output signal yₖ₊₂ output by the dynamic system and yₖ₊₁, where yₖ₊₂ is sampled during a sampling period k+2 and is generated one sampling period after yₖ₊₁ is generated. If the dynamic system is a relative degree two system, the DDRS formulates a desired response of the dynamic system as being the second order desired response. The relative degree two system takes two sample periods to change an output of the dynamic system based on an input to the dynamic system. For example, when an input to the dynamic system is uₖ, the relative degree one system outputs yₖ₊₂, which is two sample periods after yₖ. The DDRS generates equations (26)-(34) based on the relative degree two system. The relative degree two system is a further example of the dynamic system 16.

The DDRS substitutes CBᵤ=0 in equation (18) to output:

\tilde{y}ₖ₊₁=CA\tilde{x}ₖ+CB_{d}\tilde{d}ₖ+CFₖ+D_{d}\tilde{d}ₖ₊₁ (27)

The DDRS generates \tilde{y}ₖ₊₂ from \tilde{y}ₖ₊₁ of equation (27) as being:

\tilde{y}ₖ₊₂=CA\tilde{x}ₖ₊₁+CB_{d}\tilde{d}ₖ₊₁+CFₖ₊₁+D_{d}\tilde{d}ₖ₊₂ (28)

where \tilde{d}ₖ₊₂ is an incremental discrete disturbance signal and can also be represented as a difference between a discrete disturbance signal dₖ₊₂ input to the dynamic system and dₖ₊₁, where dₖ₊₂ is sampled during a sampling period k+2 and is generated one sampling period after dₖ₊₁ is generated, and Fₖ₊₁ is generated during a sampling period k+1, which is one sampling period after Fₖ is generated. The DDRS substitutes equation (14) into equation (28) to generate:

\tilde{y}ₖ₊₂=CA{A\tilde{x}ₖ+Bᵤũₖ+B_{d}\tilde{d}ₖ+Fₖ}+CB_{d}\tilde{d}ₖ₊₁+CFₖ₊₁+D_{d}\tilde{d}ₖ₊₂ (29)

The DDRS substitutes equations (15), (27), (29), and Dᵤ=0 into equation (26) to generate:

CA²\tilde{x}ₖ+CABᵤũₖ+CAB_{d}\tilde{d}ₖ+CAFₖ+CB_{d}\tilde{d}ₖ₊₁+CFₖ₊₁+D_{d}\tilde{d}ₖ₊₂ . . . −(1+α){CA\tilde{x}ₖ+CB_{d}\tilde{d}ₖ+CFₖ+D_{d}\tilde{d}ₖ₊₁}+α{C\tilde{x}ₖ+D_{d}\tilde{d}ₖ}=(1−α)tₛ\tilde{v}ₖ (30)

The DDRS solves for ũₖ in equation (30) to output:

ũₖ=|CABᵤ|⁻¹{(1−α)tₛ\tilde{v}ₖ+[(1+α)CA−CA²−αC]\tilde{x}ₖ+[(1+α)C−CA]Fₖ−CFₖ₊₁ . . . . +[(1+α)CB_{d}−CAB_{d}−αD_{d}]\tilde{d}ₖ+[(1+α)D_{d}−CB_{d}]\tilde{d}ₖ₊₁−D_{d}\tilde{d}ₖ₊₂} (31)

When x̅ₜ, d̅ₜ, ūₜ, and y̅ₜ are constant, with respect to the time t, then:

Fₖ₊₁=tₛƒ( x̅ₖ₊₁,ūₖ₊₁, d̅ₖ₊₁)=Fₖ (32)

Equation (32) is calculated, by the DDRS, based on values of the derivative \dot{x}ₜ or an estimation algorithm that computes the derivative \dot{x}ₜ at the current sample xₜ. The DDRS substitutes \tilde{d}ₖ₊₁=2\tilde{d}ₖ, \tilde{d}ₖ₊₂=3\tilde{d}ₖ, and equation (32) into equation (31) to generate:

ũₖ=|CABᵤ|⁻¹{(1−α)tₛ\tilde{v}ₖ+[(1+α)CA−CA²−αC]\tilde{x}ₖ+[αC−CA]Fₖ . . . +[(α−1)CB_{d}+(α−1)D_{d}−CAB_{d}]\tilde{d}ₖ} (33)

The DDRS substitutes K₅ as being |CABᵤ|⁻¹(1−α)tₛ, K₆ as being |CABᵤ|⁻¹[(1+α)CA−CA²−αC], K₇ as being |CABᵤ|⁻¹[αC−CA], Kₑ as being |CABᵤ|⁻¹[(α−1)CB_{d}+(α−1)D_{d}−CAB_{d}], \tilde{x}ₖ=0, and equation (33) into equation (24) to output:

uₖ=uₖ₋₁+K₅\tilde{v}ₖ+K₇Fₖ+Kₑ\tilde{d}ₖ (34)

It is noted that \tilde{x}ₖ=0 when x̅ₖ=xₖ.

It is noted that in an alternative embodiment, if the dynamic system is of a relative degree n, the DDRS formulates an n^{th} order desired response of dynamic system 16, where n is an integer greater than two.

The DDRS calculates the first, second, or alternatively the nth order desired response upon receiving a selection, via the input device, regarding a number, such as 1, 2 or alternatively n^{th}, of a desired response. As an example, upon receiving from the person via the input device that a desired response has a first number, the DDRS applies an Euler's approximation to an integrator:

\dot{y}ₜ=vₜ (35)

where vₜ is a continuous form of vₖ.
to generate

yₖ₊₁−yₖ=tₛvₖ (36)

The DDRS generates an incremental form of equation (36) to output the first order desired response. As another example, upon receiving from the person via the input device that a desired response is second order, the DDRS applies an Euler's approximation to a combination of an integrator and the first order desired response of the dynamic system. The combination is represented as:

τÿₜ+\dot{y}ₜ=vₜ (37)

where \dot{y}ₜ is a derivative, with respect to the time t, of yₜ, and ÿₜ is a derivative, with respect to the time t, of \dot{y}ₜ. The DDRS applies an Euler's approximation to the combination to generate:

yₖ₊₂−(1+α)yₖ₊₁+αyₖ=(1−α)tₛvₖ (38)

The DDRS generates an incremental form of equation (38) to output the second desired response.

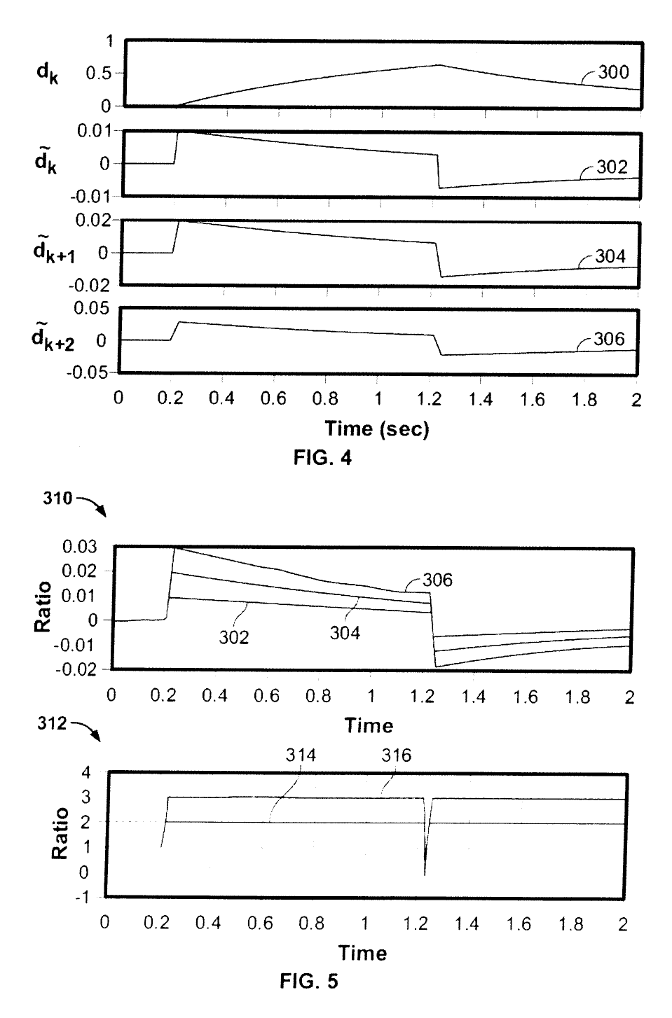

FIG. 4 shows an embodiment of a plurality of plots 300, 302, 304, 206, and 308 that may be used for reducing an effect of a disturbance. DDRS 14 calculates and may generate plot 300, which is an example of dₖ corresponding to the relative degree one system versus the time t. Moreover, DDRS 14 calculates and may generate plot 302, which is an example of \tilde{d}ₖ plotted versus the time t and which is generated as a difference between dₖ and dₖ₋₁, where dₖ₋₁ is a discrete disturbance signal input to dynamic system 16 and measured by a sensor, such as a temperature or a pressure sensor, one sampling period before dₖ is measured by the sensor. Moreover, DDRS 14 calculates and may generate plot 304, which is an example of \tilde{d}ₖ₊₁ plotted versus the time t and which is generated as a difference between dₖ₊₁ and dₖ, where \tilde{d}ₖ₊₁ is an incremental discrete disturbance signal at k+1, where dₖ₊₁ is a discrete disturbance signal input to dynamic system 16 and measured by a sensor, such as a temperature or a pressure sensor, one sampling period before dₖ is measured by the sensor. Additionally, DDRS 14 calculates and may generate plot 306, which is an example of \tilde{d}ₖ₊₂ plotted versus the time t and which is generated as a difference between dₖ₊₂ and dₖ₊₁, where \tilde{d}ₖ₊₂ is an incremental discrete disturbance signal at k+2, where dₖ₊₂ is a discrete disturbance signal input to dynamic system 16 and measured by a sensor, such as a temperature or a pressure sensor, one sampling period before dₖ₊₁ is measured by the sensor.

FIG. 5 shows a plurality of exemplary graphs 310 and 312 that may be used to facilitate reducing an effect of a disturbance. Graph 310 includes plots 302, 304, and 306, and graph 312 illustrates a plot of a ratio 314, versus the time t, of plots 304 and 302, and a ratio 316, versus the time t, of plots 306 and 302. DDRS 14 generates ratios 314 and 316. It is noted that for the relative degree one system, the ratio 314 is two, and therefore, for the relative degree one system, \tilde{d}ₖ₊₁=2*\tilde{d}ₖ. Moreover, it is noted that for the relative degree one system, the ratio 316 is three, and therefore, for the relative degree one system, \tilde{d}ₖ₊₂=3*\tilde{d}ₖ. In an alternative embodiment, for the relative degree n system, DDRS 14 determines \tilde{d}ₖ₊ₙ from \tilde{d}ₖ in a similar manner in which \tilde{d}ₖ₊₁ and \tilde{d}ₖ₊₂ are determined from \tilde{d}ₖ.

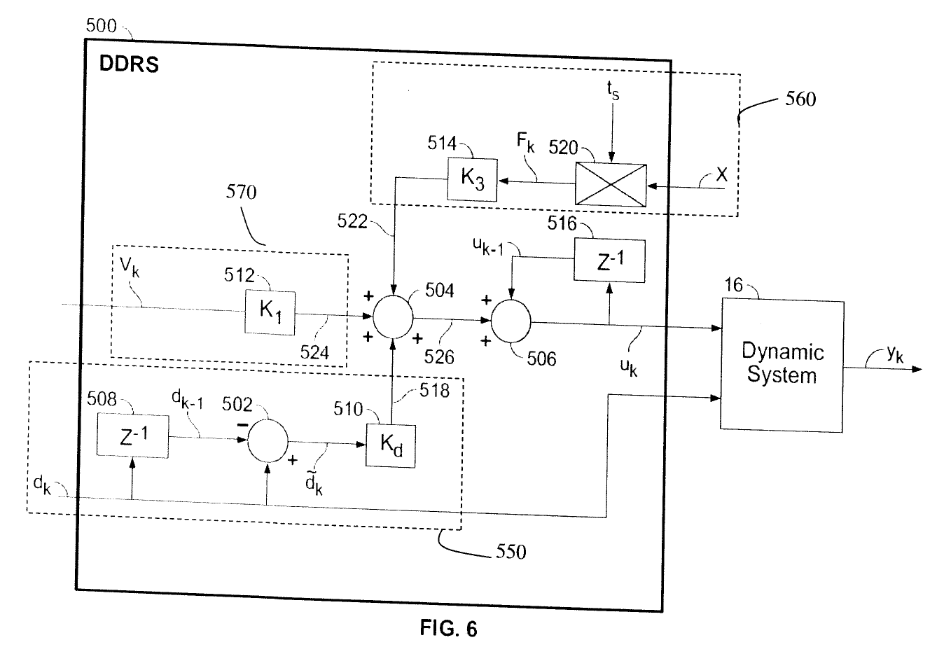

FIG. 6 is a block diagram of an exemplary DDRS 500, which maybe used with system 10 (shown in FIG. 1) as a replacement for DDRS 14. Specifically, DDRS 500 may be used in system 10 to replace DDRS 14.

In this example, the feedthru section 570, feedforward section 550 and feedback section 560 are shown. The DDRS 500 can be implemented with various hardware and software elements. The feedback gain matrix 514, the feedthru gain matrix 512 and the feedforward gain matrix 510 are calculated as detailed herein using inverse system dynamics and processed with the computed linear models.

In this depicted example, the DDRS comprises a subtractor 502, a plurality of adders 504 and 506, a plurality of multipliers 508, 510, 512, 514, 516, and 520, and where K₁, K₃, and K_{d} are from equation (25). The inverse system dynamics associated with processing K₁, K₃, and K_{d} and the implementation in the DDRS are one of the unique attributes.

In this example, multiplier 508 receives the discrete disturbance signal dₖ and multiples dₖ with 1/z, which is an inverse z-transform, to output the discrete disturbance signal dₖ₋₁. Adder 502 receives the discrete disturbance signal dₖ and the discrete disturbance signal dₖ₋₁, subtracts the discrete disturbance signal dₖ₋₁ from the discrete disturbance signal dₖ to output the incremental discrete disturbance signal \tilde{d}ₖ. Multiplier 510 multiplies the incremental discrete disturbance signal \tilde{d}ₖ with K_{d} to output a multiplier output signal 518.

Multiplier 520 multiplies the derivative \dot{x}ₜ of the state xₜ with tₛ to output Fₖ. Multiplier 514 receives Fₖ and multiplies Fₖ with K₃ to output a multiplier output signal 522. Multiplier 512 receives vₖ and multiplies vₖ with K₁ to output a multiplier output signal 524. Adder 504 receives multiplier output signals 518, 522, and 524, adds the multiplier output signals 518, 522, and 524 to generate an adder output signal 526, which is uₖ−uₖ₋₁ in equation (25) and is equal to ũₖ. Multiplier 516 receives uₖ and multiplies uₖ with 1/z to output uₖ₋₁. Adder 506 adds ũₖ and uₖ₋₁ to output uₖ. During initialization of DDRS 500, an initial value, such as zero, of uₖ, is provided by the person to DDRS 14 via the input device. Upon receiving the initial value and ũₖ, adder 506 outputs additional values of compensated control signal uₖ. Dynamic system 16 receives uₖ from DDRS 14 and uₖ reduces an effect of dₖ on yₖ. It should be understood there are numerous other designs that can be used to establish the feedthru section 570, feedback section 560 and feedforward section 550.

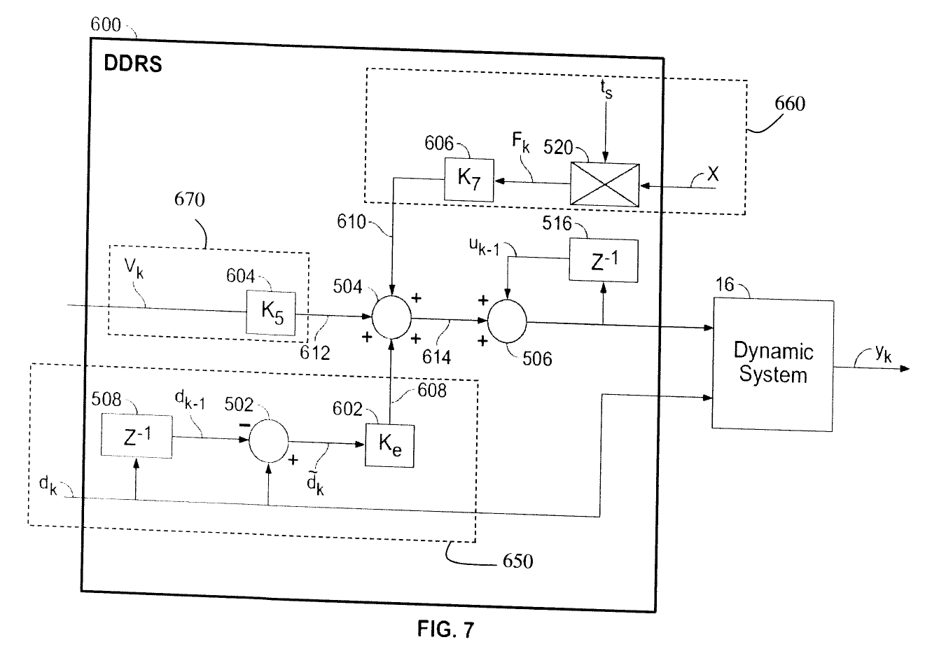

FIG. 7 is a block diagram of an alternative embodiment of a DDRS 600 that may be used with system 10 (shown in FIG. 1) as a replacement for DDRS 14. The feedforward section 650, feedback section 660 and feedthru section 670 are shown. In this additional example, DDRS 600 includes subtractor 502, adders 502, 504, and 506, a plurality of multipliers 602, 604, and 606, and multipliers 508, 516, and 520.

Multiplier 602 multiplies the incremental discrete disturbance signal \tilde{d}ₖ with Kₑ to output a multiplier output signal 608. Multiplier 606 receives Fₖ and multiplies Fₖ with K₇ to output a multiplier output signal 610. Multiplier 604 receives vₖ and multiplies vₖ with K₅ to output a multiplier output signal 612. Adder 504 receives multiplier output signals 608, 610, and 612, adds the multiplier output signals 608, 610, and 612 to generate an adder output signal 614, which is uₖ−uₖ₋₁ in equation (34) and is equal to ũₖ. Dynamic system 16 receives compensated control signal uₖ from DDRS 14 and uₖ reduces an effect of dₖ on yₖ.

It should be understood that the inverse dynamics associated with the processing of the variables such as K₁, K₃, K_{d}, K₅, K₇, and Kₑ change based on a degree of dynamic system and based on other factors, such as the time constant τ. Thus the system is able to dynamically adjust and derive improved performance.

FIG. 8 shows a plurality of simulated exemplary graphs 700, 702, 704, 706, and 708 including a plurality of exemplary outputs from dynamic system 16. Graph 700 plots a disturbance signal 710 versus time t, graph 702 illustrates a plot of a disturbance signal 712 versus the time t, graph 704 represents a dynamic system output signal 714 versus time t and a desired response 716 of dynamic system 16 versus time t. Moreover, graph 706 illustrates a plot of a dynamic system output signal 718 versus time t and a desired response 720 of dynamic system 16 versus time t. Additionally, graph 708 illustrates a plot of a dynamic system output signal 722 versus time t and a desired response 724 of dynamic system 16 versus time t. When disturbance signals 710 and 712 are input to dynamic system 16 and no disturbance is applied to dynamic system 16, dynamic system 16 generates dynamic system output signals 714, 718, and 722. Moreover, a difference between dynamic system output signal 714 and desired response 716 is small and dynamic system output signal 714 quickly converges to desired response 716. Additionally, a coupling between desired response 720 and dynamic system output signal 718 is small, such as 9%-12%. Further, a coupling between desired response 724 and dynamic system output signal 722 is small, such as 9%-12%.

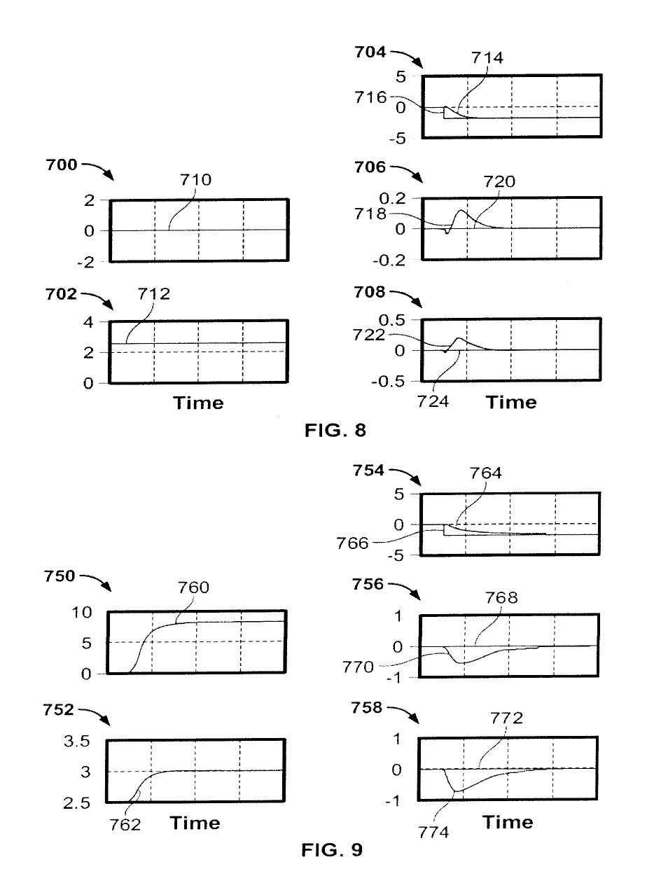

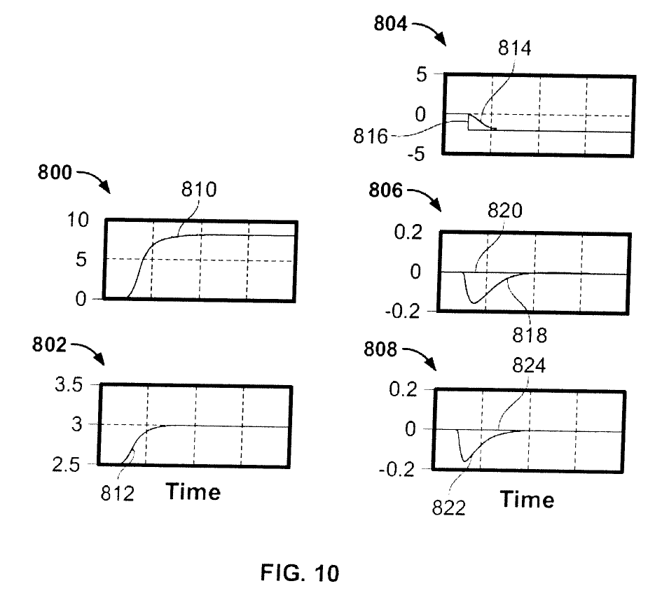

FIG. 9 illustrates a plurality of simulated exemplary graphs 750, 752, 754, 756, and 758. Graph 750 illustrates a plot of a disturbance signal 760 versus the time t, graph 752 illustrates a plot of a disturbance signal 762 versus the time t, and graph 754 illustrates a plot of a dynamic system output signal 764 versus the time t and a desired response 766 of a dynamic system, which is not coupled to DDRS 14, versus the time t. Moreover, graph 756 illustrates a plot of a dynamic system output signal 770 versus the time t and a desired response 768 of a dynamic system, which is not coupled to DDRS 14, versus the time t. Additionally, graph 758 illustrates a plot of a dynamic system output signal 774 versus the time t and a desired response 772 of a dynamic system, which is not coupled to DDRS 14, versus the time t. When disturbance signals 760 and 762 are input to a dynamic system, which is not coupled to DDRS 14, the dynamic system generates dynamic system output signals 764, 770, and 774. Moreover, a dynamic system output signal 764 slowly converges to desired response 766. Additionally, a coupling between desired response 770 and dynamic system output signal 770 is large, such as 38%-42%. Further, a coupling between desired response 772 and dynamic system output signal 774 is large, such as 38%-42%.

FIG. 10 illustrates a plurality of simulated exemplary graphs 800, 802, 804, 806, and 808. Graph 800 illustrates a plot of a disturbance signal 810 versus the time t, graph 802 illustrates a plot of a disturbance signal 812 versus the time t, graph 804 illustrates a plot of a dynamic system output signal 814 versus the time t and a desired response 816 of dynamic system 16 versus the time t. Moreover, graph 806 illustrates a plot of a dynamic system output signal 818 versus the time t and a desired response 820 of dynamic system 16 versus the time t. Additionally, graph 808 illustrates a plot of a dynamic system output signal 822 versus the time t and a desired response 824 of dynamic system 16 versus the time t. When disturbance signals 810 and 812 are input to dynamic system 16, dynamic system 16 generates dynamic system output signals 814, 818, and 822. Moreover, a difference between dynamic system output signal 814 and desired response 816 is small and dynamic system output signal 814 quickly converges to desired response 816. Additionally, a coupling between desired response 820 and dynamic system output signal 818 is small, such as 7%-8%. Further, a coupling between desired response 824 and dynamic system output signal 822 is small, such as 7%-8%. It is evident from FIGS. 8 and 10 that the coupling between desired response 820 and dynamic system output signal 818 is similar to that between desired response 720 and dynamic system output signal 718, and the coupling between desired response 824 and dynamic system output signal 822 is similar to that between desired response 724 and dynamic system output signal 722 when no disturbance is present.

Technical effects of the described systems and methods for reducing an effect of a disturbance include reducing an effect of the discrete disturbance signal dₖ on dynamic system output signal yₖ. The effect of the discrete disturbance signal dₖ is reduced or eliminated by generating an equation, such as equation (25) or (34), for the incremental discrete DDRS output signal ũₖ as a function of the incremental discrete disturbance signal \tilde{d}ₖ, which is a change of a difference between the discrete disturbance signal dₖ and the discrete disturbance signal dₖ₋₁. By generating ũₖ as a function of \tilde{d}ₖ, changes, such as \tilde{d}ₖ, in the discrete disturbance signal dₖ are considered in reducing the effect of the discrete disturbance signal dₖ and DDRS 14 attenuates an impact of the discrete disturbance signal dₖ over dynamic system 16 over a broad frequency range, such as ranging from and including 0 hertz (Hz) to the closed loop bandwidth of the dynamic system. For systems such as gas turbine this range would be from 0 Hz to 4 Hz, for electrical systems this range would be from 0 Hz to 10 Kilohertz (KHz). Other technical effects of the systems and methods for reducing an effect of a disturbance include reducing coupling between a desired response of dynamic system 16 and dynamic system output signal 24. Yet other technical effects include providing a quick convergence of a dynamic system output signal 24 to a desired response. It is noted that DDRS 14 does not wait to receive yₖ₋₁ to generate uₖ and changes uₖ at the same time or during the same sampling period as dₖ is received by dynamic system 16. Hence, disturbance effects are reduced on the dynamic system 16 before the disturbance enters and adversely affects dynamic system 16.

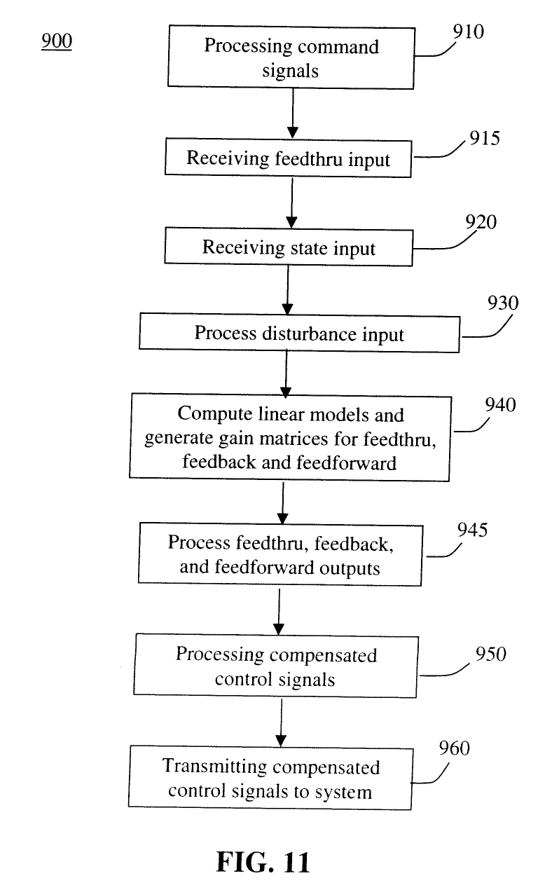

Referring to FIG. 11, a flow chart illustrates the dynamic disturbance rejection processing 900 according to one embodiment. There is typically some processing of input command signals 910 although these signals can be, for example, direct manual command inputs or pre-processed command inputs that are processed in a controller section 12 such as shown in FIG. 1. These input command signals can be a single command signal or multiple input command signals. These input command signals are received in the feedthru section 915 as feedthru information. In a steady state operation, the command signals or feedthru processing may not be used in processing the compensated control signal and only the feedback section and feedforward section would be processed.

The processing continues with receiving state feedback 920. In general terms, the state feedback information provides certain details of the parameters that influence the performance of the system. The input to the feedback portion of the logic can be sensed, calculated, or estimated values of the state derivatives. For illustrative purposes, one example of the state feedback information relates to energy-storing elements in the dynamic system that affects the outputs of interest, such as mechanical inertias, pressure storage, heat storage, potential energy, and kinetic energy.

Disturbance input data is also received and processed 930 that provides an indication of the potential disturbance and influence to the system. The disturbance data can be estimates or based upon measurements.

The disturbance input data establishes feedforward information that together with the state feedback information and optionally the feedthru information are used to calculate changes to the controlled inputs to reject or mitigate disturbance effect on the system outputs.

Linear models are computed for each of the feedthru information, feedback information and feedforward information. The corresponding feedthru gain matrix, feedback gain matrix, and feedforward gain matrix are computed using inverse system dynamics 940.

The processing continues 945 as the feedthru linear models are multiplied by the feedthru gain matrix, the feedback linear models are multiplied by the feedback gain matrix, and the feedforward linear models are multiplied by the feedforward gain matrix.

According to one embodiment, the one or more feedthru inputs are multiplied by the corresponding feedthru matrix (such as K₁ and K₅) with the proper matching of dimensions. In an example of the feedback, the state derivative is multiplied by the corresponding matrix, (such as K₃ and K₇) that has the dimension number of states columns, by the number of controlled inputs rows, and added into the control input command. The input to the feed forward section is sensed, calculated, or estimated values of the disturbance inputs to the system. The past value of the disturbance is subtracted from the current value to determine how much the disturbance has changed in one sample. The incremental disturbance is then multiplied by the corresponding matrix, (such as K_{d} and Kₑ) that has the dimension number of disturbance inputs, by number of controlled inputs rows and added into the control input command.

The compensated control signals are then processed 950. Finally, the resulting compensated control signals are transmitted to the dynamic system 960.

The system processing of the linear models in certain embodiments uses transfer functions, state space models, and/or other analytic models that relate the dynamic effect of the controlled inputs, state information and disturbance inputs on the system outputs to cancel or attenuate the disturbance inputs impact on the system outputs. In one embodiment the disturbance rejection system uses feedthru, feedback and feedforward components to dynamically reject the disturbance over a range of frequencies.

According to one aspect, the feedthru, feedback and feedforward gains are computed by using an inverse of the system dynamics. The dynamic disturbance rejection according to one embodiment is based on dynamic inversion controls technology and in certain aspects incorporates a full state feedback controller.

In a general sense, the controlled inputs are adjusted to compensate for the effect of the disturbances and hold the controlled outputs to their desired values. The derivation of the values of the feedthru matrices (such as K₁ and K₅) feedback matrices (such as K₃ and K₇) and the feedforward matrices (such as K_{d} and Kₑ) are provided herein.

The formulation in one aspect is based on inversion of a dynamic model, and if the model changes with operating condition the dynamic disturbance rejection can be recomputed for the new conditions. This can occur either as scheduling of the matrices or re-computation of the matrices on-line using, for example, a model or a parameterized model.

In another embodiment, if there is a change to the system due to different operating mode, fault, or failure, the feedforward can be recomputed based on the status of the changed system. According to one embodiment, there may be limits applied to the feedback or feedforward parameters and if the limits are exceeded, the processing can be recomputed or used the prior calculated or an projected number based on the prior calculations.

The DDRS changes uₖ at the same time the disturbance signal dₜ is input to the dynamic system. Accordingly, an impact of the disturbance signal dₜ on the dynamic system is reduced. It should be understood that the equations are for illustrative purposes of an example for the processing of compensate control signal uₖ and other inverse system dynamic formulations can be used for processing.

A further feature of the invention relates to adaptive online processing. Adaptive online control is detailed in certain embodiments in the commonly owned patents U.S. Pat. No. 6,823,253, and U.S. Pat. No. 6,823,675, herein incorporated by reference. According to one embodiment, the DDRS can compute the feedforward gain, such as K_{d}, at least one of before and during energization of the dynamic system. The DDRS can compute K_{d} on-line in real time while the dynamic system is being operated by a power source. However, the DDRS can also compute K_{d} off-line before the dynamic system is provided power by the power source. Likewise, the DDRS can compute the feedforward gain, feedback gain and/or the feedthru gain via online processing, offline processing, scheduled processing and adaptive online processing. The processing can also be scheduled or otherwise programmed to occur based on various conditions.

In one embodiment, the effect of disturbances on the system outputs is reduced thereby increasing the steady state and transient performance, stability, speed of response, accuracy, and/or efficiency of the system or process. The compensated control signal is ultimately a full scale value that processes and manipulates some controlled device such as an actuator.

While the invention has been described in terms of various specific embodiments, those skilled in the art will recognize that the invention can be practiced with modification within the spirit and scope of the claims.

What is claimed is:

1. A method for processing a compensated control signal reducing disturbance effects on a dynamic system, comprising:
receiving at least one input command signal;
obtaining state information about said system;
processing at least one disturbance signal;
computing a feedthru gain, a feedback gain, and a feedforward gain, said feedthru gain being computed from said at least one input command signal, said feedback gain being computed from said state information, and said feedforward gain being computed from said disturbance signal, wherein said feedthru gain, said feedback gain and said feedforward gain are each computed using inverse system dynamics;
processing at least one said compensated control signal using at least one of said feedthru gain, said feedback gain, and said feedforward gain; and
transmitting said at least one compensated control signal to said dynamic system.

2. The method according to claim 1, wherein said processing of said compensated control signal uses only said feedforward gain and said feedback gain.

3. The method according to claim 1, wherein said disturbance signal is from at least one of a measured system disturbance and an estimated system disturbance.

4. The method according to claim 1, wherein said computing of at least one of said feedforward gain, said feedback gain and said feedthru gain is by at least one of online processing, offline processing, scheduled processing, and adaptive online processing.

5. The method according to claim 1, wherein said state information is obtained from at least one of a measured state value and an estimated state value.

6. The method in accordance with claim 1, wherein said computing of said feedforward gain comprises calculating a difference between two sampled disturbance values during consecutive sampling periods and generating a disturbance signal increment, wherein said disturbance signal increment is used in said computing of said feedforward gain.

7. The method according to claim 1, wherein said computing of said feedthru gain, said feedback gain and said feedforward gain each comprises computing linear models and respectively generating a feedthru gain matrix, a feedback gain matrix and a feedforward gain matrix.

8. The method according to claim 7, wherein said computing said linear models uses at least one of transfer functions, state space models, and analytic models.

9. The method according to claim 1, wherein said compensated control signal is processed according to uₖ=uₖ₋₁+K₁\tilde{v}ₖ+K₃Fₖ+K_{d}\tilde{d}ₖ, wherein K₁ is the feedthru gain, K₃ is the feedback gain, and K_{d} is the feedforward gain.

10. The method according to claim 1, wherein said compensated control signal is processed for an n^{th} order desired response for said dynamic system having a relative degree n, where n is an integer greater than two.

11. A dynamic disturbance rejection device for reducing an effect of a disturbance signal on an output of a controlled system, comprising:
at least one input command signal wherein said command signal effects one or more parameters of said controlled system;
a feedback section with state information about said controlled system, wherein said feedback section generates a feedback gain output using inverse system dynamics;
a feedforward section with disturbance information, wherein said feedforward section generates a feedforward output using inverse system dynamics;
a feedthru section coupled to said input command signal, wherein said feedforward section generates a feedforward output using inverse system dynamics; and
a processing unit coupled to said feedthru section, said feedback section and said feedforward section, wherein said processing unit processes a compensated control signal for said controlled system from said feedthru output, said feedback output and said feedforward output.

12. The device according to claim 11, wherein said state information is selected from at least one of the group consisting of measured state values and estimated state values.

13. The device according to claim 11, further comprising one or more sensors coupled to said controlled system, wherein said sensors provide said state information and said disturbance information.

14. The device according to claim 11, wherein said disturbance information is from at least one of the group consisting of measured parameters and estimated parameters.

15. The device according to claim 11, wherein said feedback section is a full state feedback controller.

16. The device according to claim 11, wherein said feedforward section is configured to generate a disturbance increment from the disturbance information as a difference between two sampled disturbance values during consecutive sampling periods.

17. The device according to claim 11, wherein said device comprises at least subtractors, adders, and multipliers.

18. A system for reducing disturbance effects on a dynamic apparatus, comprising:
receiving at least one of command inputs, state feedback, and disturbance values;
calculating an incremental disturbance by subtracting a past disturbance value from a current disturbance value;
processing a feedback gain matrix, a feedforward gain matrix, and a feedthru gain matrix by inverse system dynamics;
multiplying the incremental disturbance by the feedforward gain matrix to produce a feedforward output;
multiplying the state feedback by the feedback gain matrix to produce a feedback output;
multiplying the command inputs by the feedthru gain matrix to produce a feedthru output; and
processing said feedthru output, said feedback output, and said feedforward output to generate a compensated control signal, wherein said compensated control signal is transmitted to said dynamic apparatus.

19. The system according to claim 18, wherein the dynamic apparatus is at least one of a single-input-single-output, multiple-input-multiple-output, single-input-multiple-output, and multiple-input-single-output.

20. The system according to claim 18, wherein for a steady state condition the feedthru output is approximately zero.
